(19) United States
(12) Patent Application Publication
(10) Pub. No.: US 2024/0037916 A1
(43) Pub. Date: Feb. 1, 2024

(54) SYSTEMS AND METHODS FOR CREATING USED PART MACHINE LEARNING TRAINING IMAGES

(71) Applicant: Caterpillar Inc., Peoria, IL (US)

(72) Inventor: Taylor Jensen, Chicago, IL (US)

(21) Appl. No.: 17/874,109

(22) Filed: Jul. 26, 2022

(51) Int. Cl. G06V 10/774; G06T 15/20; G06T 19/20

(52) U.S. Cl. CPC G06V 10/774; G06T 15/20; G06T 19/20; G06T 2219/004; G06T 2219/2012

(57) ABSTRACT

A method for creating part images for training machine learning models, the method including: receiving a three-dimensional model of a part, wherein the part model includes physical properties of the part including weight; simulating dropping the part on a surface from a selected height and orientation; randomly placing one or more camera positions around the dropped part; rendering an image of the part model for each of the one or more camera positions; and labeling each image with part information.

### TECHNICAL FIELD

This patent application is directed to used machine part identification, and more specifically, to creating used part machine learning training images.

### BACKGROUND

As equipment is used, certain parts progressively wear out and should be replaced when either the part fails or it has worn to a point that it starts to degrade performance of the equipment. It can sometimes be difficult to identify a worn part as certain identifying features may have worn off, part numbers may be obscured by other parts on the machine, and/or the part is dirty.

Image recognition has been used to identify parts in order to identify parts, verify that the correct part is being used for replacement, and to verify parts received from a supplier are correctly labeled, for example. Image recognition techniques are known, and some methods have been developed to identify objects, such as parts. These techniques can include machine learning models, such as neural networks. A neural network is typically trained with a library of images of known parts, for example. However, it can be difficult to gather a suitable number of images (i.e., photographs) of a part from different angles, lighting conditions, and levels of wear. Furthermore, each image requires manual identification.

Efforts have been made to more efficiently create training images. For example, U.S. Pat. No. 7,151,850 to Suzuki et al. (hereinafter “Suzuki”), describes an apparatus and method for setting teaching data required for image processing for e.g., electronic components. Suzuki is directed to an evaluation image generator that generates a plurality of evaluation images by performing image processing on a simple subject image. The image processing includes at least shading processing in consideration of a possible tilt of the subject and contrast processing in consideration of possible lighting variations. Suzuki still relies on at least some manual involvement to generate and categorize the subject simple image and only provides simulated tilt. Thus, Suzuki may not produce images from different angles and does not account for environmental conditions (e.g., dirt) or wear on used machine parts, for example.

Thus, there are still opportunities to improve on the efficiency of creating training images for machine learning. The example systems and methods described herein are directed toward overcoming one or more of the deficiencies described above and/or other problems with the prior art.

### SUMMARY

In some aspects, the techniques described herein relate to a method for creating part images for training machine learning models, the method including: receiving a three-dimensional model of a part, wherein the part model includes physical properties of the part such as weight; simulating dropping the part on a surface from a selected height and orientation; randomly placing one or more camera positions around the dropped part; rendering an image of the part model for each of the one or more camera positions; and labeling each image with part information.

In some aspects, the techniques described herein relate to a method, further including applying simulated wear to the three-dimensional part model of the part.

In some aspects, the techniques described herein relate to a method, further including applying a color to the three-dimensional part model of the part.

In some aspects, the techniques described herein relate to a method, further including a background image in the rendered images.

In some aspects, the techniques described herein relate to a method, wherein simulating dropping the part includes applying a physics based model to determine how the part comes to rest on the surface.

In some aspects, the techniques described herein relate to a method, wherein part information includes associating a part identification number with the each image.

In some aspects, the techniques described herein relate to a system for creating part images for training machine learning models, including: one or more processors; and one or more memory devices having stored thereon instructions that when executed by the one or more processors cause the one or more processors to: receive a three-dimensional model of a part, wherein the part model includes physical properties of the part such as weight; simulate dropping the part on a surface from a selected height and orientation; randomly place one or more camera positions around the dropped part; render an image of the part model for each of the one or more camera positions; and label each image with part information.

In some aspects, the techniques described herein relate to a system, further including applying simulated wear to the three-dimensional part model of the part.

In some aspects, the techniques described herein relate to a system, further including applying a color to the three-dimensional part model of the part.

In some aspects, the techniques described herein relate to a system, further including a background image in the rendered images.

In some aspects, the techniques described herein relate to a system, wherein simulating dropping the part includes applying a physics based model to determine how the part comes to rest on the surface.

In some aspects, the techniques described herein relate to a system, wherein part information includes associating a part identification number with the each image.

In some aspects, the techniques described herein relate to one or more non-transitory computer-readable media storing computer-executable instructions that, when executed by one or more processors, cause the one or more processors to perform operations including: training a wear estimate model, including: receiving a three-dimensional model of a part, wherein the part model includes physical properties of the part such as weight; simulating dropping the part on a surface from a selected height and orientation; randomly placing one or more camera positions around the dropped part; rendering an image of the part model for each of the one or more camera positions; and labeling each image with part information.

In some aspects, the techniques described herein relate to one or more non-transitory computer-readable media, further including applying simulated wear to the three-dimensional part model of the part.

In some aspects, the techniques described herein relate to one or more non-transitory computer-readable media, further including applying a color to the three-dimensional part model of the part.

In some aspects, the techniques described herein relate to one or more non-transitory computer-readable media, further including a background image in the rendered images.

In some aspects, the techniques described herein relate to one or more non-transitory computer-readable media, wherein simulating dropping the part includes applying a physics based model to determine how the part comes to rest on the surface.

In some aspects, the techniques described herein relate to one or more non-transitory computer-readable media, wherein part information includes associating a part identification number with the each image.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 illustrates a training image creation system for creating used part machine learning training images according to some embodiments of the disclosed technology;

FIG. 2 is a flow diagram showing steps for creating used part training images according to some embodiments of the disclosed technology;

FIG. 3 is an isometric view depicting a three-dimensional model of a used machine part positioned for rendering according to some embodiments of the disclosed technology;

FIG. 4 is a flow diagram showing a method for creating used part training images according to some embodiments of the disclosed technology;

FIG. 5 is a block diagram illustrating an overview of devices on which some implementations can operate;

FIG. 6 is a block diagram illustrating an overview of an environment in which some implementations can operate; and

FIG. 7 is a block diagram illustrating components which, in some implementations, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all suitable modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed are methods and systems for automatically creating used part machine learning training images. Currently, it is difficult to gather and catalog enough images to automatically identify products or parts in a field environment. Images can be difficult to gather as it requires manual collection and identification. This is particularly true with respect to different part orientations, color, lighting, backgrounds, wear, and obscuring contaminants such as dirt and rust. The disclosed technology is directed to automatically creating realistic images of used parts by artificially adding wear and tear to three-dimensional (3D) part drawings. In addition, the system can add realistic backgrounds, color, lighting, and rendered surface rust and/or dirt, for example.

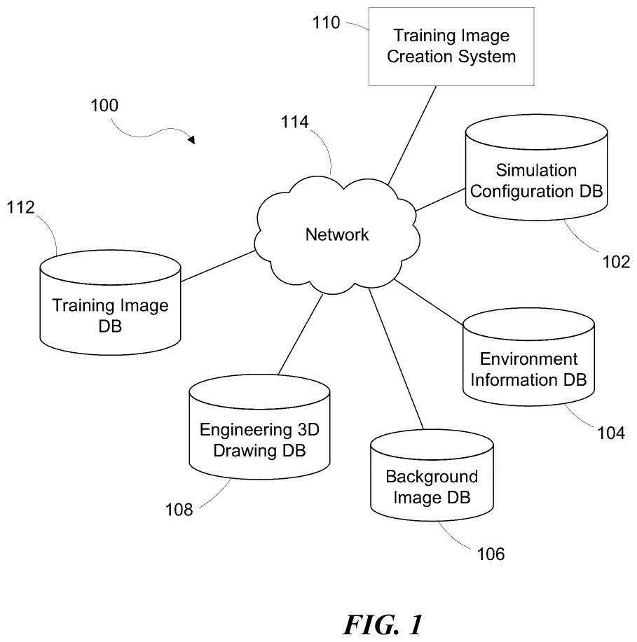

FIG. 1 illustrates a used part machine learning training images creation system 100 according to some embodiments of the disclosed technology. The system 100 can include a training image creation module 110 that is in communication, via network 114, with a simulation configuration database 102, an environment information database 104, a background image database 106, an engineering 3D drawing database 108, and a training image database 112. In some embodiments, the training image creation module 110 combines information from the simulation configuration database 102, the environment information database 104, the background image database 106, and the engineering 3D drawing database 108 to create training images. The training images are then stored in the training image database 112.

The simulation configuration database 102 contains settings for the kind of wear applied to the machine part and how the digital environment is set up. The environment information database 104 contains information describing the environment space, materials, etc. that the part object will interact with. The background image database 106 contains 360 degree images in a format that also contains visual lighting information. The engineering 3D drawing database 108 contains 3D models of various machine parts.

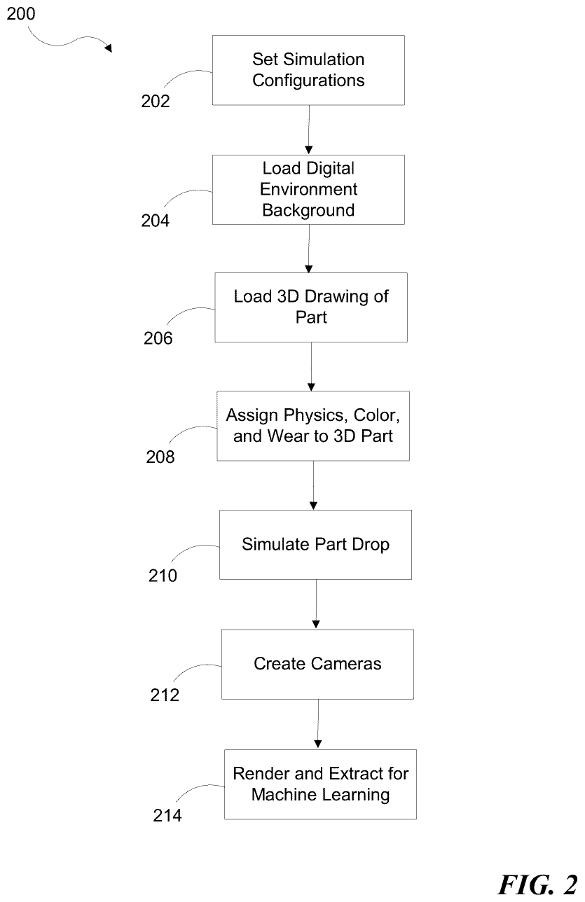

FIG. 2 is a flow diagram showing a process 200 for creating used part training images according to some embodiments of the disclosed technology. In some embodiments the training image creation module 110 can receive configuration information from database 102 and set the simulation configurations, at step 202. This can include setting the high and low ranges adjustment strengths to be randomly made to the digital environment as well as set what main environment features to use. The digital environment background image and information is received from databases 104 and 106 and loaded into the digital environment at step 204. This can include creating a floor for an object to sit on in the environment. The 3D part drawing is loaded at step 206. This can include loading a 3D part drawing from database 108 into the digital environment and lifting the part away from the floor a specified height and randomly rotating it. At step 208, physics, weight, color, and wear are assigned to the part. In some embodiments, the weight of the particular object is included in the three-dimensional model of the part. In other embodiments, a predefined static weight measure can be used for all parts. The amount of synthetic wear applied to the 3D part can be randomly applied via the limits set in the simulation configurations. Color includes any color selected in the simulation configuration. Wear can include rust and dirt size, strength, color, and dent size and quantity. At step 210, the system simulates dropping the part onto the floor and notes the final resting place of the object after being dropped. The final frame of the simulation is set as the current environment. At step 212, cameras are configured and randomly placed around the final location of the part. Each camera is pointed at the part and, at step 214, an image is rendered for each camera's point-of-view, which can be saved in training image database 112. The system can also calculate from the angle of the camera to the object in 3D space the location of the 3D object in the image and save it in an easily consumable format for machine learning. In some embodiments, a bounding box is included in the image to facilitate (e.g., reduce processing) training a machine learning model. The process 200 can be repeated for any desired amount or number of overall simulation runs, number of digital environment backgrounds, and number of 3D parts. This information is gathered from the simulation configurations.

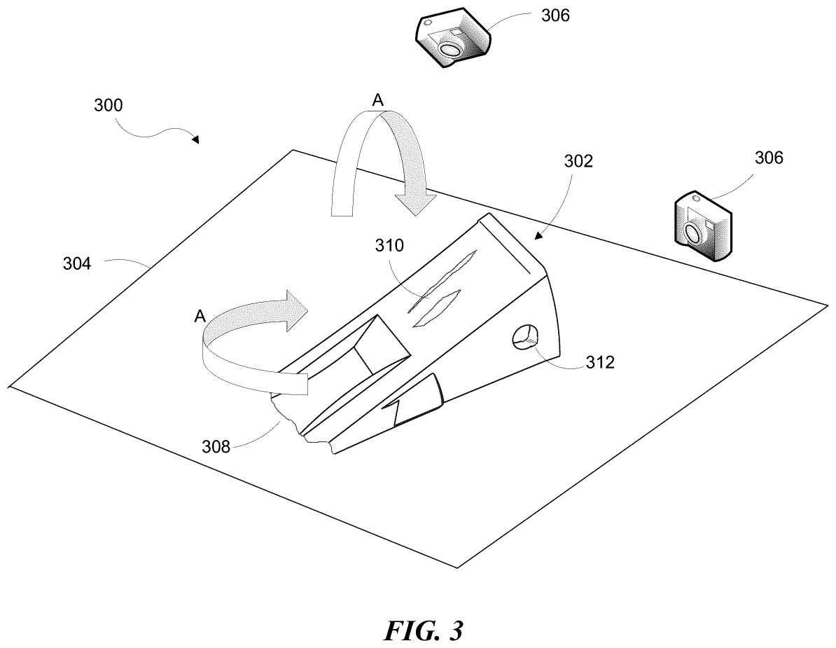

FIG. 3 is an isometric view depicting a 3D model 302 of a used machine part positioned in a digital environment 300 for creating training images according to some embodiments of the disclosed technology. In this example, the used machine part is an excavator tooth. The part model 302 can be lifted away from floor 304 and rotated (as indicated by arrows A) before dropping the part onto the floor 304. The cameras 306 are randomly positioned and oriented around the part 302 to create the renderings of the part.

In some embodiments, the renderings can include patterns, such as gouges 310 and worn bearing or mounting holes, such as mounting hole damage 312. It should be understood that computer-aided design (CAD) programs have the capability to render photo-realistic images including surfaces representing different materials such as metal, plastic, and rubber to name a few. The renderings can also include rust, dirt, and grease, to name a few.

In some embodiments, a physics-based wear model can be applied to the 3D part model 302 to predict a plurality of wear patterns for a part. In some embodiments, a physics based wear model can include estimating wear based on the number of cycles of movement with a particular load. The number of cycles can include counting movements of a particular part or estimating typical cycles per hour. For example, estimating the wear of an excavator tooth can include calculating the product of the number of boom, arm, and/or bucket movements, a known force applied by the excavator arm, and a wear factor based on material (e.g., soil, sand, clay, or rock). The result can represent the amount of material (i.e., metal) that is chipped (e.g., chip 308), worn, or otherwise removed from a tooth. This type of physics-based model can be run for different numbers of cycles and conditions to create different wear patterns and severities.

Because the training images are produced from CAD models, images of a part as viewed from different angles can easily be created by randomly rotating, dropping, and positioning cameras. Also, different lighting effects and backgrounds can be applied to the images. In some embodiments, simulated rust and dirt can be applied to represent typical conditions of a part in use. Many CAD programs allow for parametric modeling by which dimensions of the part can be managed by tabulated data. Using parametric modeling, the creation of part images for all of the combinations of part size, configuration, wear severity, cycles, and load, for example, can be automated.

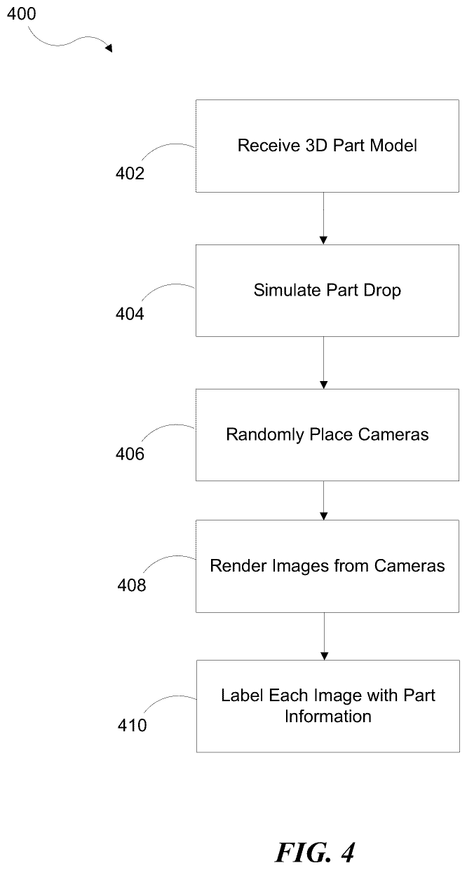

FIG. 4 is a flow diagram showing a method 400 for creating used part training images according to some embodiments of the disclosed technology. The method 400 can include receiving a 3D part model at step 402. At step 404, the method includes simulating a part drop. Cameras are randomly placed around the dropped part at step 406. At step 408, images of the part and surrounding environment are rendered for each camera. At step 410, each image is labeled with part information, such as part number and camera distance, for example. Once the training image library for one or more parts is created, a corresponding machine learning part identification model (e.g., a convolutional neural network) can be trained using the library.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

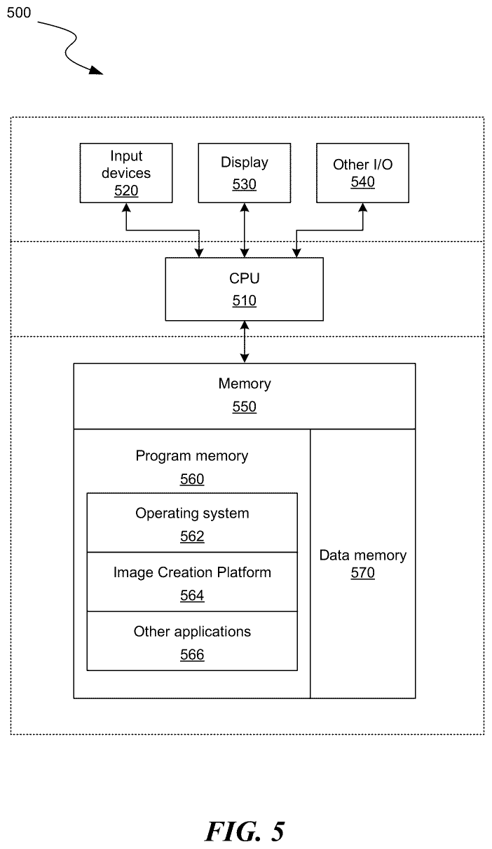

Several implementations are discussed below in more detail in reference to the figures. FIG. 5 is a block diagram illustrating an overview of devices on which some implementations of the disclosed technology can operate. The devices can comprise hardware components of a device 500 that automatically creates training images for training a part identification machine learning model, for example. Device 500 can include one or more input devices 520 that provide input to the CPU (processor) 510, notifying it of actions. The actions are typically mediated by a hardware controller that interprets the signals received from the input device and communicates the information to the CPU 510 using a communication protocol. Input devices 520 include, for example, a mouse, a keyboard, a touchscreen, an infrared sensor, a touchpad, a wearable input device, a camera- or image-based input device, a microphone, or other user input devices.

CPU 510 can be a single processing unit or multiple processing units in a device or distributed across multiple devices. CPU 510 can be coupled to other hardware devices, for example, with the use of a bus, such as a PCI bus or SCSI bus. The CPU 510 can communicate with a hardware controller for devices, such as for a display 530. Display 530 can be used to display text and graphics. In some examples, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 540 can also be coupled to the processor, such as a network card, video card, audio card, USB, FireWire or other external device, sensor, camera, printer, speakers, CD-ROM drive, DVD drive, disk drive, or Blu-Ray device.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The CPU 510 can have access to a memory 550. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 550 can include program memory 560 that stores programs and software, such as an operating system 562, Image Creation Platform 564, and other application programs 566. Memory 550 can also include data memory 570 that can include database information, etc., which can be provided to the program memory 560 or any element of the device 500.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

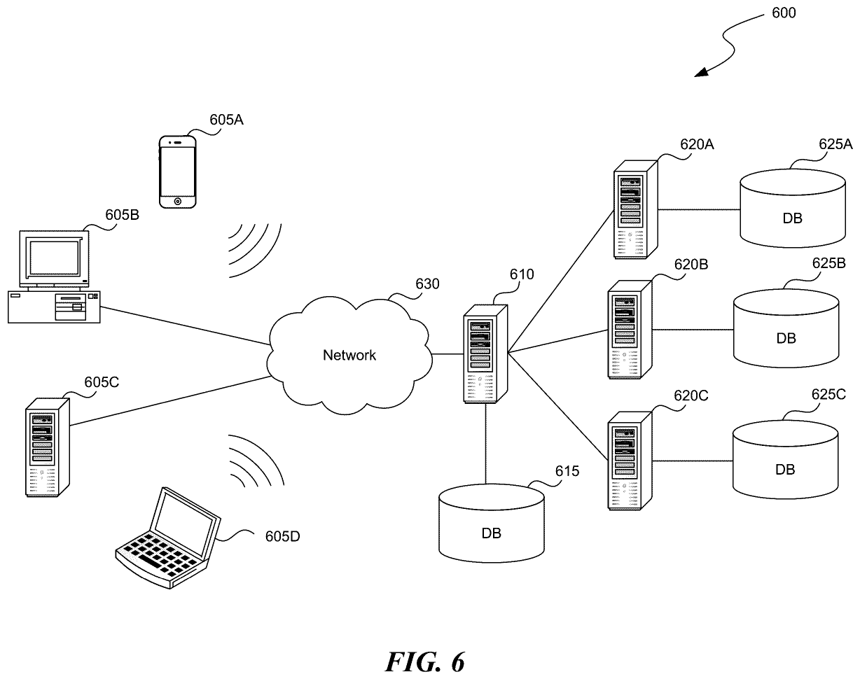

FIG. 6 is a block diagram illustrating an overview of an environment 600 in which some implementations of the disclosed technology can operate. Environment 600 can include one or more client computing devices 605A-D, examples of which can include device 500. Client computing devices 605 can operate in a networked environment using logical connections through network 630 to one or more remote computers, such as a server computing device 610.

In some implementations, server computing device 610 can be an edge server that receives client requests and coordinates fulfillment of those requests through other servers, such as servers 620A-C. Server computing devices 610 and 620 can comprise computing systems, such as device 500. Though each server computing device 610 and 620 is displayed logically as a single server, server computing devices can each be a distributed computing environment encompassing multiple computing devices located at the same or at geographically disparate physical locations. In some implementations, each server computing device 620 corresponds to a group of servers.

Client computing devices 605 and server computing devices 610 and 620 can each act as a server or client to other server/client devices. Server 610 can connect to a database 615. Servers 620A-C can each connect to a corresponding database 625A-C. As discussed above, each server 620 can correspond to a group of servers, and each of these servers can share a database or can have their own database. Databases 615 and 625 can warehouse (e.g., store) information. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. Network 630 may be the Internet or some other public or private network. Client computing devices 605 can be connected to network 630 through a network interface, such as by wired or wireless communication. While the connections between server 610 and servers 620 are shown as separate connections, these connections can be any kind of local, wide area, wired, or wireless network, including network 630 or a separate public or private network.

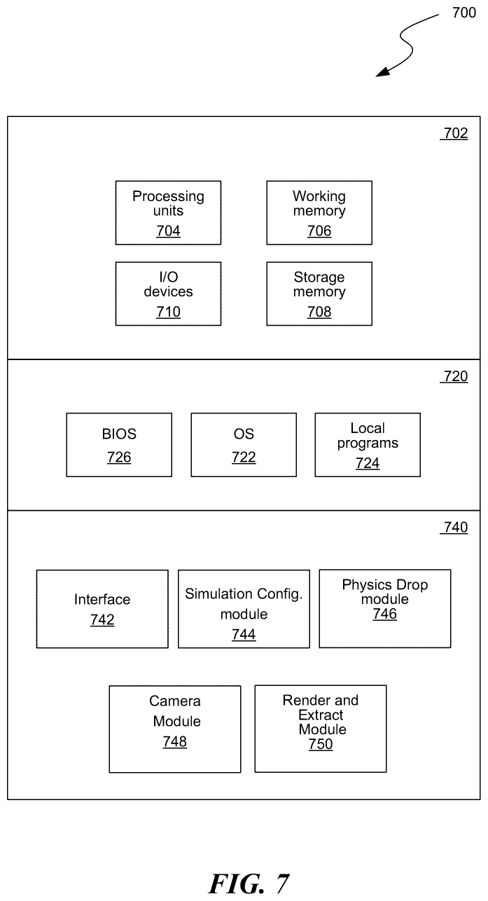

FIG. 7 is a block diagram illustrating components 700 which, in some implementations, can be used in a system employing the disclosed technology. The components 700 include hardware 702, general software 720, and specialized components 740. As discussed above, a system implementing the disclosed technology can use various hardware, including processing units 704 (e.g., CPUs, GPUs, APUs, etc.), working memory 706, storage memory 708, and input and output devices 710. Components 700 can be implemented in a client computing device such as client computing devices 605 or on a server computing device, such as server computing device 610 or 620.

General software 720 can include various applications, including an operating system 722, local programs 724, and a basic input output system (BIOS) 726. Specialized components 740 can be subcomponents of a general software application 720, such as local programs 724. Specialized components 740 can include a simulation configuration module 744, a physics based drop simulation module 746, a camera module 748, an image render and extract module 750, and components that can be used for transferring data and controlling the specialized components, such as interface 742. In some implementations, components 700 can be in a computing system that is distributed across multiple computing devices or can be an interface to a server-based application executing one or more of specialized components 740.

Those skilled in the art will appreciate that the components illustrated in FIGS. 5-7 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, a used part machine learning training images creation system can include a simulation configuration module 744, a physics based drop simulation module 746, a camera module 748, an image render and extract module 750 (FIG. 7). In operation, the simulation configuration module 744 sets the high and low ranges adjustment strengths to be randomly made to the digital environment, set what main environment features to use, as well as set the number of times the process repeats. The physics based drop simulation module 746 applies the part weight, physics, and initial position from the floor to simulate dropping the part onto the floor to provide a random orientation of the part in the digital environment. The camera module 748 randomly selects the position of each camera and orients or aims the cameras at the part to create the rendered images. The image render and extraction module 750, renders the images from the cameras and labels the part images with part information such as part number.

The disclosed technology efficiently generates numerous different training images of a part by randomly selecting the part height, orientation, and camera positions as well as automatically selecting various combinations of lighting, wear, backgrounds, and colors. Simulating a part drop adds another random aspect to the orientation of the part for the rendered training image. Furthermore, the disclosed process can be automatically applied to many different parts to create a catalog of training images.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method for creating part images for training machine learning models, the method comprising:
receiving a three-dimensional model of a part, wherein the part model includes physical properties of the part including weight;
simulating dropping the part on a surface from a selected height and orientation;
randomly placing one or more camera positions around the dropped part;
rendering an image of the part model for each of the one or more camera positions; and
labeling each image with part information.

2. The method of claim 1, further comprising applying simulated wear to the three-dimensional part model of the part.

3. The method of claim 1, further comprising applying a color to the three-dimensional part model of the part.

4. The method of claim 1, further comprising including a background image in the rendered images.

5. The method of claim 1, wherein simulating dropping the part comprises applying a physics based model to determine how the part comes to rest on the surface.

6. The method of claim 1, wherein part information comprises associating a part identification number with the each image.

7. A system for creating part images for training machine learning models, comprising:
one or more processors; and
one or more memory devices having stored thereon instructions that when executed by the one or more processors cause the one or more processors to:
receive a three-dimensional model of a part, wherein the part model includes physical properties of the part including weight;
simulate dropping the part on a surface from a selected height and orientation;
randomly place one or more camera positions around the dropped part;
render an image of the part model for each of the one or more camera positions; and
label each image with part information.

8. The system of claim 7, further comprising applying simulated wear to the three-dimensional part model of the part.

9. The system of claim 7, further comprising applying a color to the three-dimensional part model of the part.

10. The system of claim 7, further comprising including a background image in the rendered images.

11. The system of claim 7, wherein simulating dropping the part comprises applying a physics based model to determine how the part comes to rest on the surface.

12. The system of claim 7, wherein part information comprises associating a part identification number with the each image.

13. One or more non-transitory computer-readable media storing computer-executable instructions that, when executed by one or more processors, cause the one or more processors to perform operations comprising:
training a wear estimate model, including:
receiving a three-dimensional model of a part, wherein the part model includes physical properties of the part including weight;
simulating dropping the part on a surface from a selected height and orientation;
randomly placing one or more camera positions around the dropped part;
rendering an image of the part model for each of the one or more camera positions; and
labeling each image with part information.

14. The one or more non-transitory computer-readable media of claim 13, further comprising applying simulated wear to the three-dimensional part model of the part.

15. The one or more non-transitory computer-readable media of claim 13, further comprising applying a color to the three-dimensional part model of the part.

16. The one or more non-transitory computer-readable media of claim 13, further comprising including a background image in the rendered images.

17. The one or more non-transitory computer-readable media of claim 13, wherein simulating dropping the part comprises applying a physics based model to determine how the part comes to rest on the surface.

18. The one or more non-transitory computer-readable media of claim 13, wherein part information comprises associating a part identification number with the each image.
